(19) United States
(12) Patent Application Publication
(10) Pub. No.: US 2012/0084007 A1
(43) Pub. Date: Apr. 5, 2012

(54) SYSTEM AND METHOD FOR DECLUSTERING SUBSURFACE DATA ON A PER-SLICE BASIS

(75) Inventors: Thomas T. Tran, La Mirada, CA (US); Michael W. Waite, City Beach (AU); Michael J. Pyrcz, Humble, TX (US)

(73) Assignee: Chevron U.S.A. Inc.

(21) Appl. No.: 12/894,898

(22) Filed: Sep. 30, 2010

(51) Int. Cl. G06F 19/00; G01V 9/00; G01V 1/30

(52) U.S. Cl. 702/6; 702/14

(57) ABSTRACT

Wellbore data samples taken within a subsurface volume of interest are declustered. A weighting-based, interpolating technique is employed in a layer-based, two dimensional manner to separate slices within the subsurface volume of interest. The performance of declustering on a slice-by-slice basis may make the process less costly and/or may reduce certain artifacts or effects associated with subsurface data interpolation.

### FIELD OF THE INVENTION

The invention relates to the declustering of subsurface wellbore data samples taken within a subsurface volume of interest to reduce biases caused by, among other things, oversampling in hydrocarbon-rich strata.

### BACKGROUND OF THE INVENTION

The acquisition and processing of samples of one or more properties of a subsurface volume of interest taken within wellbores formed in the subsurface volume of interest are known. However, wellbores are typically formed to penetrate sections within the subsurface volume of interest that carry the most hydrocarbon. For example, deviated and horizontal wellbores produce the most economic hydrocarbon-bearing zones of the subsurface volume. As such, samples taken within the wellbores may be over-representative of the distribution of properties within these hydrocarbon-bearing zones within the subsurface volume of interest. As a result statistical descriptions (e.g., histograms) of the subsurface volume of interest that rely on the samples taken within the wellbores may be biased by the oversampling in strata having certain characteristics in common (e.g., corresponding to the presence of hydrocarbons).

Various declustering and interpolation techniques are known in the art. Such techniques include, for example, weighting-based interpolation techniques such as kriging, in which declustering weights are assigned to locations within the subsurface volume of interest. The declustering weights are then applied to measured values of a property within the subsurface volume of interest before statistical descriptions of the subsurface volume of interest are generated from the weighted samples. These techniques are generally applied in a three-dimensional manner over the entire model of the subsurface volume of interest.

### SUMMARY

One aspect of the invention relates to a computer-implemented method of declustering a property within a subsurface volume of interest. In one embodiment, the method comprises obtaining values of a property for some locations within a three-dimensional subsurface volume of interest such that for some locations within the subsurface volume of interest the value of the property is unknown; defining a first slice through the subsurface volume of interest, the first slice including locations for which the property is known and locations for which the property is unknown; and determining declustering weights for the obtained values for the property across the first slice. The determination of the declustering weights for obtained values of the property at locations in the first slice is made by applying an interpolating technique to the known values of the property at locations in the first slice.

Another aspect of the invention relates to a system configured to interpolate a property within a subsurface volume of interest. In one embodiment, the system comprises electronic storage and one or more processors. The electronic storage stores values of a property for some locations within a three-dimensional subsurface volume of interest such that for some locations within the subsurface volume of interest the value of the property is unknown. The one or more processors are configured to execute computer program modules including a slicing module and a weight determination module. The slicing module is configured to define slices through the subsurface volume of interest such that individual slices include locations for which the property is known and locations for which the property is unknown. The weight determination module is configured to determine declustering weights for the obtained values for the property on a slice-by-slice basis. The determination of the declustering weights for obtained values of the property on a slice-by-slice basis is made by separately applying an interpolating technique to the known values of the property at locations in individual slices.

Yet another aspect of the invention relates to an electronic, computer-readable, non-transitory storage medium storing instructions configured to cause one or more processors to perform a method of interpolating a property within a subsurface volume of interest. In one embodiment, the method comprises obtaining values of a property for some locations within a three-dimensional subsurface volume of interest such that for some locations within the subsurface volume of interest the value of the property is unknown; defining a first slice through the subsurface volume of interest, the first slice including locations for which the property is known and locations for which the property is unknown; and determining declustering weights for the obtained values for the property across the first slice. The determination of the declustering weights for obtained values of the property at locations in the first slice is made by applying an interpolating technique to the known values of the property at locations in the first slice.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system configured to interpolate values of a property within a subsurface volume of interest, in accordance with one or more embodiments of the invention.

FIG. 2 illustrates a subsurface volume of interest, in accordance with one or more embodiments of the invention.

FIG. 3 illustrates a slice within a subsurface volume of interest, in accordance with one or more embodiments of the invention.

FIG. 4 illustrates a method for interpolating values of a property within a subsurface volume of interest, calculating the declustering weights, and applying the declustering weights to generate an unbiased statistical description of the subsurface wellbore data, according to one or more embodiments of the invention.

### DETAILED DESCRIPTION

The present technology may be described and implemented in the general context of a system and computer methods to be executed by a computer. Such computer-executable instructions may include programs, routines, objects, components, data structures, and computer software technologies that can be used to perform particular tasks and process abstract data types. Software implementations of the present technology may be coded in different languages for application in a variety of computing platforms and environments. It will be appreciated that the scope and underlying principles of the present technology are not limited to any particular computer software technology.

Moreover, those skilled in the art will appreciate that the present technology may be practiced using any one or combination of hardware and software configurations, including but not limited to a system having single and/or multi-processer computer processors system, hand-held devices, programmable consumer electronics, mini-computers, mainframe computers, and the like. The technology may also be practiced in distributed computing environments where tasks are performed by servers or other processing devices that are linked through one or more data communications networks. In a distributed computing environment, program modules may be located in both local and remote computer storage media including memory storage devices.

Also, an article of manufacture for use with a computer processor, such as a CD, pre-recorded disk or other equivalent devices, may include a computer program storage medium and program means recorded thereon for directing the computer processor to facilitate the implementation and practice of the present technology. Such devices and articles of manufacture also fall within the spirit and scope of the present technology.

Referring now to the drawings, embodiments of the present technology will be described. The technology can be implemented in numerous ways, including for example as a system (including a computer processing system), a method (including a computer implemented method), an apparatus, a computer readable medium, a computer program product, a graphical user interface, a web portal, or a data structure tangibly fixed in a computer readable memory. Several embodiments of the present technology are discussed below. The appended drawings illustrate only typical embodiments of the present technology and therefore are not to be considered limiting of its scope and breadth.

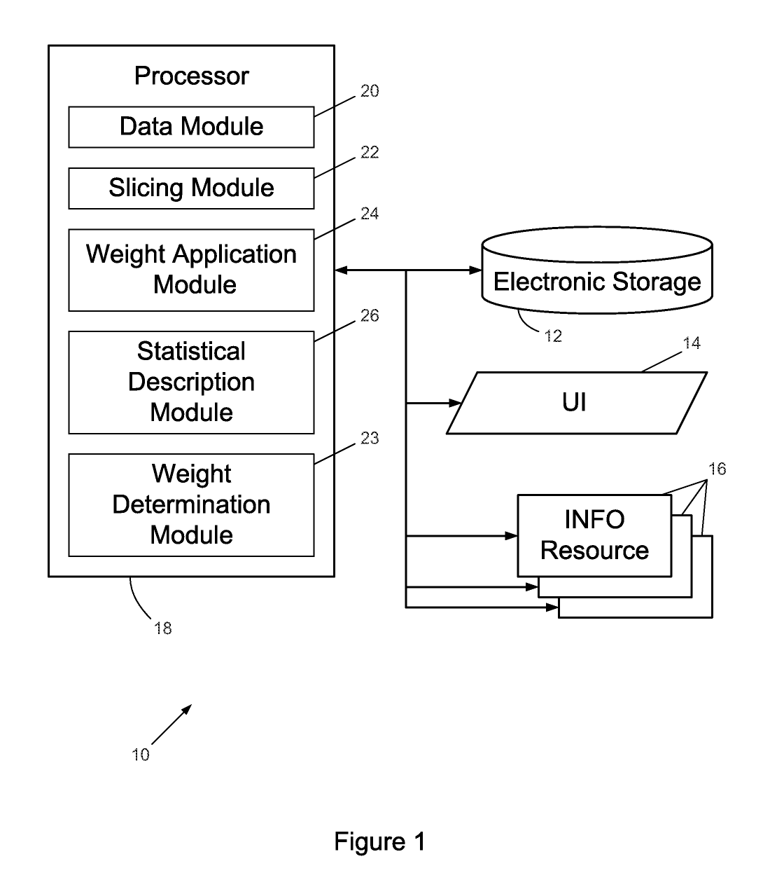

FIG. 1 illustrates a system 10 configured to interpolate wellbore data samples taken within subsurface volume of interest. In some implementations, system 10 is configured to determine declustering weights in a layer-based, two dimensional manner. The weights determined by system 10 in the layer-based manner may be implemented to weight samples of parameters taken within wellbores, and/or to update or adjust other weights determined according to other schemes. Weighted samples may be used to generate a statistical description of the subsurface volume of interest. In one embodiment, system 10 includes one or more of electronic storage 12, a user interface 14, one or more information resources 16, one or more processors 18, and/or other components.

In one embodiment, the electronic storage 12 comprises electronic storage media that electronically stores information. The electronic storage media of the electronic storage 12 may include system storage that is provided integrally (i.e., substantially non-removable) with the system 10 and/or removable storage that is removably connectable to the system 10 via, for example, a port (e.g., a USB port, a firewire port, etc.) or a drive (e.g., a disk drive, etc.). The electronic storage 12 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage 12 may store software algorithms, information determined by the processor 18, information received via the user interface 14, information received from the information resources 16, and/or other information that enables the system 10 to function as described herein. The electronic storage 12 may be a separate component within the system 10, or the electronic storage 12 may be provided integrally with one or more other components of the system 10 (e.g., the processor 18).

The user interface 14 is configured to provide an interface between the system 100 and a user through which the user may provide information to and receive information from the system 10. This enables data, results, and/or instructions and any other communicable items, collectively referred to as “information,” to be communicated between the user and the system 10. As used herein, the term “user” may refer to a single individual or a group of individuals who may be working in coordination. Examples of interface devices suitable for inclusion in the user interface 14 include one or more of a keypad, buttons, switches, a keyboard, knobs, levers, a display screen, a touch screen, speakers, a microphone, an indicator light, an audible alarm, and/or a printer. In one embodiment, the user interface 14 actually includes a plurality of separate interfaces.

It is to be understood that other communication techniques, either hard-wired or wireless, are also contemplated by the present technology as the user interface 14. For example, the present technology contemplates that the user interface 14 may be integrated with a removable storage interface provided by the electronic storage 12. In this example, information may be loaded into the system 10 from removable storage (e.g., a smart card, a flash drive, a removable disk, etc.) that enables the user to customize the implementation of the system 10. Other exemplary input devices and techniques adapted for use with the system 10 as the user interface 14 include, but are not limited to, an RS-232 port, RF link, an IR link, modem (telephone, cable or other). In short, any technique for communicating information with the system 10 is contemplated by the present technology as the user interface 14.

The information resources 16 include one or more sources of information related to the geologic volume of interest. By way of non-limiting example, one of information resources 16 may include logs of downhole measurements taken through one or more wellbores formed within a subsurface volume of interest. Such logs may include measurements of porosity, impedance, saturation, resistivity, density, and/or other measurements. As another example, one of information resources 16 may include well information that describes the size, shape, location, orientation, depth, and/or other parameters of one or more wells formed within the subsurface volume of interest.

The processor 18 is configured to provide information processing capabilities in the system 10. As such, the processor 18 may include one or more of a digital processor, an analog processor, a digital circuit designed to process information, an analog circuit designed to process information, a state machine, and/or other mechanisms for electronically processing information. Although the processor 18 is shown in FIG. 1 as a single entity, this is for illustrative purposes only. In some implementations, the processor 18 may include a plurality of processing units. These processing units may be physically located within the same device or computing platform, or the processor 18 may represent processing functionality of a plurality of devices operating in coordination.

As is shown in FIG. 1, the processor 18 may be configured to execute one or more computer program modules. The one or more computer program modules may include one or more of a data module 20, a slicing module 22, a weight determination module 23, a weight application module 24, a statistical description module 26, and/or other modules. The processor 18 may be configured to execute modules 20, 22, 23, 24, and/or 26 by software; hardware; firmware; some combination of software, hardware, and/or firmware; and/or other mechanisms for configuring processing capabilities on the processor 18.

It should be appreciated that although the modules 20, 22, 23, 24, and 26 are illustrated in FIG. 1 as being co-located within a single processing unit, in implementations in which the processor 18 includes multiple processing units, one or more of the modules 20, 22, 23, 24, and/or 26 may be located remotely from the other modules. The description of the functionality provided by the different modules 20, 22, 23, 24, and/or 26 described below is for illustrative purposes, and is not intended to be limiting, as any of the modules 20, 22, 23, 24, and/or 26 may provide more or less functionality than is described. For example, one or more of the modules 20, 22, 23, 24, and/or 26 may be eliminated, and some or all of its functionality may be provided by other ones of the modules 20, 22, 23, 24, and/or 26. As another example, the processor 18 may be configured to execute one or more additional modules that may perform some or all of the functionality attributed below to one of the modules 20, 22, 23, 24, and/or 26.

The data module 20 may be configured to obtain information (e.g., data) related to the subsurface volume of interest for further processing. Such information may be received from the information resources 16, the user via the user interface 14, the electronic storage 12, and/or other information sources. An example of obtained information may include one or more logs of downhole measurements taken within one or more wellbores formed within the subsurface volume of interest. Such logs may include one or more of a wireline log, a measurement-while-drilling log, and/or other logs of measurements taken within the one or more wellbores. The information obtained by data module 20 may include information related to the wellbores within which the obtained logs were taken. Such information may include, for example, information that describes the size, shape, location, orientation, depth, and/or other parameters of one or more wellbores formed within the subsurface volume of interest Information received by the data module 20 may be utilized by one or more of modules 22, 23, 24, and/or 26. Examples of some such utilizations are described below. The data module 20 may be configured to transmit information to one or more other components of the system 10.

The data obtained by data module 20 may include a model that describes the spatial distribution of a property within the subsurface volume of interest. The model may include locations for which values of the property have been measured and/or are known. The model may include locations for which values of the property have not been measured and are not known. The property may include one or more of a reservoir property (e.g., porosity, permeability, water, oil and gas saturation, and/or other reservoir properties), a lithologic property (e.g., lithofacies category, grain size, mineralogy, and/or other lithologic properties), a geotechnical property (e.g., density, brittleness, strength, and/or other geotechnical properties), a seismic property (e.g., density, velocity, elastic properties, and/or other seismic propreties), and/or other properties. By way of non-limiting example, the model may divide the subsurface volume of interest into cells defined by a three-dimensional mesh. The mesh may be rectangular, triangular, and/or based on other polygonal shapes. The mesh may define cells having regular shapes and/or be conformed to major geologic horizons within the subsurface volume of interest. The value of the property at a given cell within the subsurface volume of interest may be obtained by data module 20, or the value of the property at the given cell may be unknown. The spacing and/or size of the cells may correspond to a sample spacing for measurements taken within wellbores formed in the subsurface volume of interest (e.g., at about 0.5 ft, and/or other sample spacing).

The slicing module 22 may be configured to define slices through the model of the subsurface volume of interest. A slice may refer to a section of the subsurface volume of interest having relatively little thickness. For example, a slice may have a thickness of a single cell, two cells, less than five cells, less than 10 cells, and/or other relatively small thickness. A slice may be planar, or may be non-planar. Examples of planar slices may include a common-time slice, a common-depth slice, a vertical slice, a horizontal slice, a planar slice oriented along the primary directions of spatial continuity of the property, and/or other planar slices. Examples of non-planar slices may include a slice defined to correspond in orientation and/or position with a horizon or layer in the subsurface volume of interest, and/or other non-planar slices.

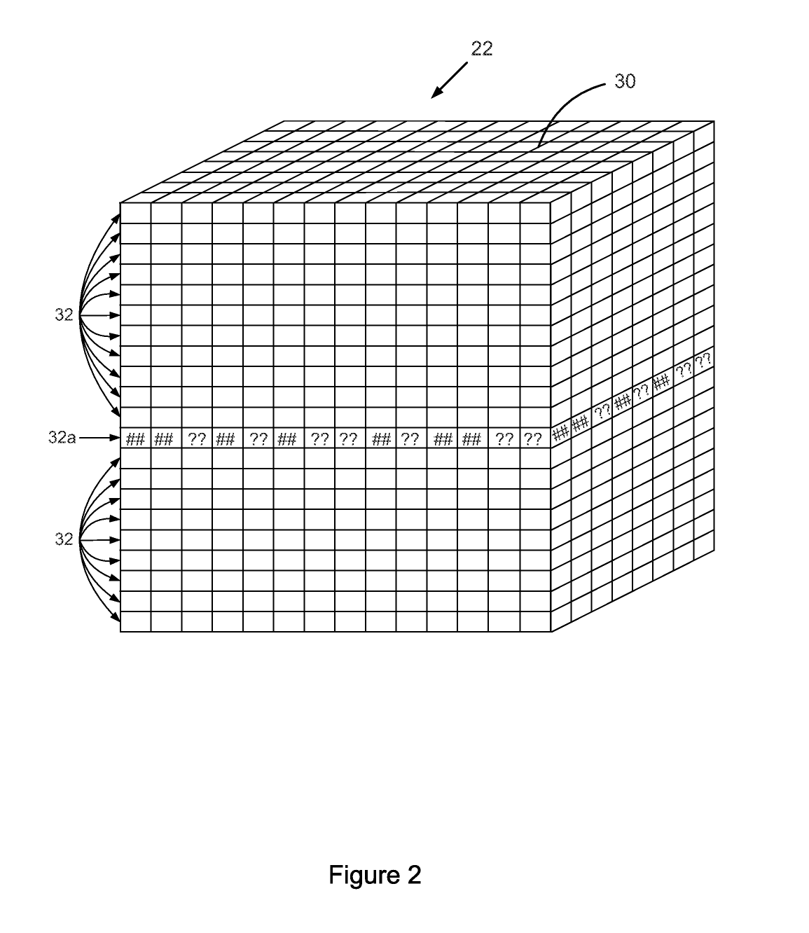

In defining slices through the model of the subsurface volume of interest, slicing module 22 effectively divides the model of the subsurface volume of interest into a set of slices. By way of illustration, FIG. 2 depicts a model of a subsurface volume of interest 28. The model 28 is divided by a mesh 30. A plurality of slices 32 are defined through model 28. As was discussed above, the cells of a given slice 32a include cells for which a value of the property is known (illustrated in FIG. 2 as being labeled with ##) and cells for which a value of the property is not known (illustrated in FIG. 2 as being labeled with ??).

Returning to FIG. 1, weight determination module 23 is configured to determine weights for values of the property measured within the wellbores. The weighting will give less relative value to samples taken oversampled regions (e.g., hydrocarbon-rich strata), and give greater relative value to samples taken in regions that are sampled less heavily. The weighting is based on the locations at which the property was measured, the spatial dependence of the property, the distribution of the wellbores within the subsurface volume of interest, the subsurface volume of interest, the manner in which the slices are defined within the subsurface volume of interest, the spacing and/or size of the cells within each slice, and/or other parameters. The determination of the weights is performed on a slice-by-slice basis. This means that for a given slice, weights for cells at which the property is known are determined based on known values at the other cells in the given slice. The determination of the weights within the given slice may be independent from known values at cells outside the given slice.

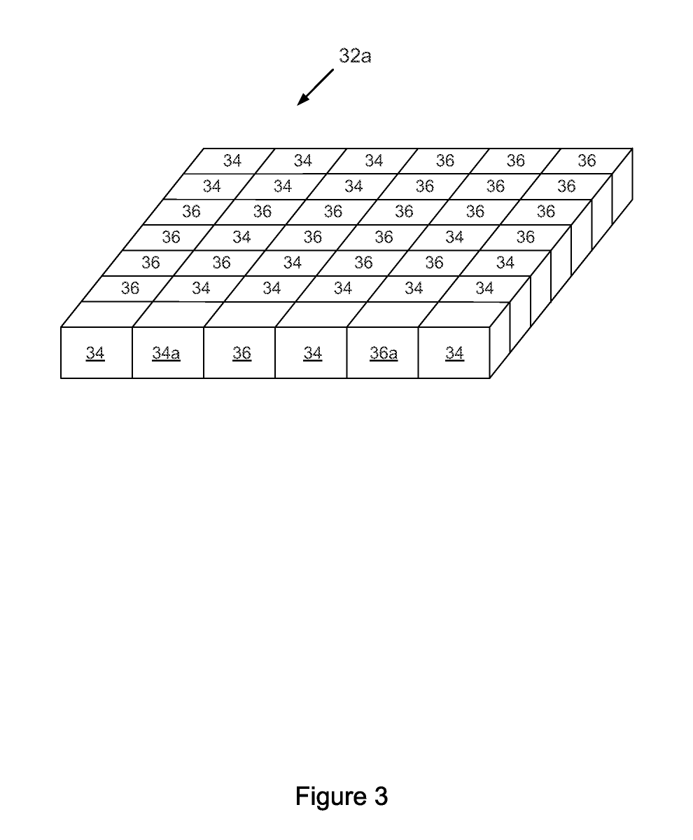

By way of illustration, FIG. 3 illustrates slice 32a including cells 34 for which values of the property are known and cells 36 for which values of the property are not known. For a given cell 34a, a declustering weight for the property may be determined from the values of the property for other ones of cells 34. Since the determination of the declustering weights is performed on a slice-by-slice basis, the determination of the weights may be made without regard for values of the property for cells in the subsurface volume of interest outside of slice 32a. For example, values from cells in adjacent slices (not shown in FIG. 3) may not be implemented in the determination of a declustering weight for the measured value of the property at given cell 34a. This segmentation of declustering weight determination on a slice-by-slice may simplify the computation involved in declustering the property. Simplification of the declustering process may yield a declustering process that is less costly with respect to one or more of processing, storage, and/or time. The determination of declustering weights segmented by slice may avoid some artifacts and/or artificial effects present in interpolating techniques that determine weights based on a three-dimensional analysis of the known values within whole model at once. For example, determination of declustering weights performed on a slice-by-slice basis may reduce occurrences of the string effect artifact, and/or other effects or artifacts.

Returning to FIG. 1, the weight determination module 23 may be configured weights for known values of the property within the slices defined by slicing module 22 in accordance with a weighting-based interpolating technique. This may include weighting-based interpolating techniques known in the art such as, for example, kriging, the inverse distance method, the polygon-of-influence technique, and/or other interpolating techniques. The determination of the declustering weights may be based on a variogram or semivariogram determined by weight determination module 23. The variogram or semivariogram may describe the degree of spatial dependence of the values of the property within the model of the subsurface volume of interest. The variogram or semivariogram may be determined on a slice-by-slice basis, or the variogram or semivariogram may be determined for the model of the subsurface volume of interest as a whole.

The weight application module 24 is configured to apply the weights determined by weight determination module 23. This may include multiplying the weights determined by weight determination module 23 to the corresponding samples.

The statistical description module 26 is configured to determine one or more statistical descriptions of the subsurface volume of interest from the weighted samples. The statistical descriptions determined by statistical description module 26 from the weighted samples will have reduced biasing due to wellbore orientation, structural dip, oversampling in hydrocarbon-rich strata, and/or other biasing effects. By way of example, statistical description module 26 may be configured to determine a histogram and/or related statistics representing the subsurface volume of interest, such as a cumulative histogram, mean, median, mode, variance, and/or other related statistics, and/or other statistical descriptions of the subsurface volume of interest.

The processor 18 may be configured to execute one or more additional modules (not shown) configured to perform additional processing on the model and/or the values of the property (known/measured and/or interpolated). For example, processor 18 may be configured to execute a statistical description module configured to determine one or more statistical descriptions of the subsurface volume of interest from the weighted samples. The statistical descriptions may be configured to determine, for example, a histogram and/or related statistics representing the subsurface volume of interest.

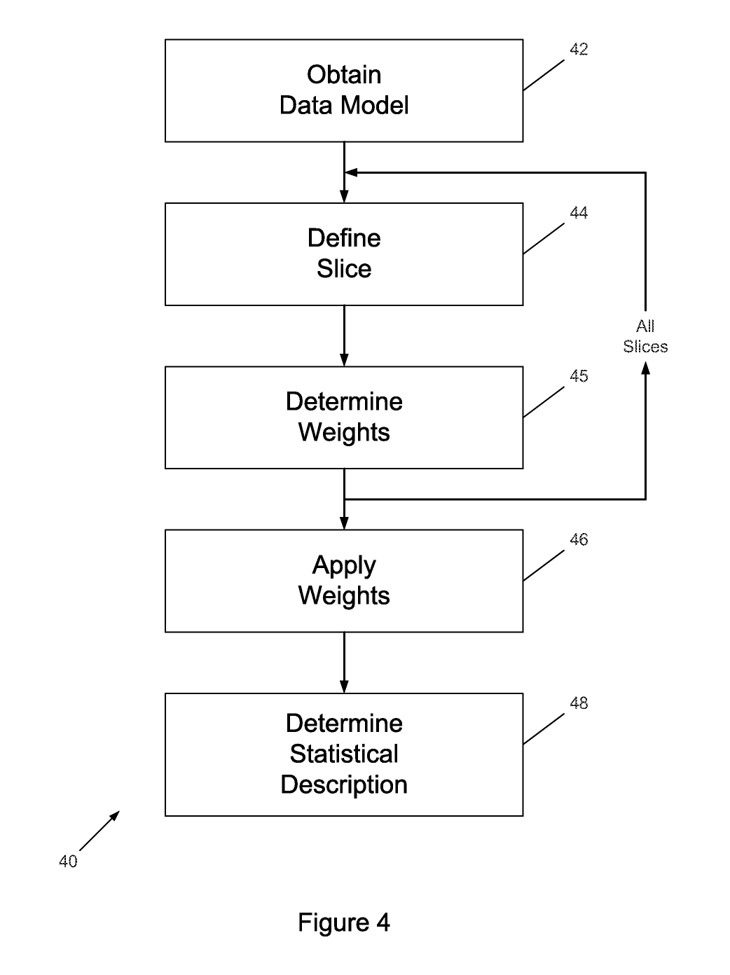

FIG. 4 illustrates a method 40 of interpolating a property within a three-dimensional subsurface volume of interest, calculating the declustering weights, and applying the declustering weights to generate an unbiased statistical description of the subsurface wellbore data. The operations of method 40 presented below are intended to be illustrative. In some embodiments, method 40 may be accomplished with one or more additional operations not described, and/or without one or more of the operations discussed. Additionally, the order in which the operations of method 40 are illustrated in FIG. 4 and described below is not intended to be limiting.

In some embodiments, method 40 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 40 in response to instructions stored electronically on an electronic storage medium. The one or more processing devices may include one or more devices configured through hardware, firmware, and/or software to be specifically designed for execution of one or more of the operations of method 40.

At an operation 42, values of the property for some locations within the subsurface volume of interest are obtained. This may include obtaining a model of the subsurface volume of interest that describes the spatial distribution of the property within the subsurface volume of interest. In the model, there may be one or more locations for which the property is not known. The model may be divided into cells by a mesh. The values for the property may include values for individual cells. For some of the cells, values of the property may not be known. In one embodiment, operation 42 is performed by a data module similar to or the same as data module 20 (shown in FIG. 1 and described above).

At an operation 44, a slice through the subsurface volume of interest is defined. This may include defining a slice through the model of the subsurface volume of interest obtained at operation 42. The slice may include locations for which values of the property are known and locations for which values of the property are not known. In one embodiment, operation 44 is performed by a slicing module similar to or the same as slicing module 22 (shown in FIG. 1 and described above).

At an operation 45, declustering weights for values of the property corresponding to locations in the slice are determined. The declustering weights are determined based on a per-slice (or slice-by-slice) basis. As such, the determination of the declustering weights may be performed without regard for known values outside of the slice. The declustering weights may be determined to facilitate interpolation, to adjust other weights, and/or for other purposes. In one embodiment, operation 45 is performed by a weight determination module similar to or the same as weight determination module 23 (shown in FIG. 1 and described above).

Method 40 loops back over operations 44 and 45 for all slices within the subsurface volume of interest. It will be appreciated that the illustration and description of the loop as including all operations 44 and 45 is not intended to be limiting. These operations could be looped individually for all slices, instead of being included in a single loop. The loop could include additional operations performed on a slice-by-slice basis (e.g., operations 46 and/or 48).

At an operation 46, the declustering weight determined at operation 45 is applied to the sample. Applying the declustering weight to the sample may include, for example, multiplying the sample by the declustering weight. In one embodiment, operation 46 is performed by a weight application module similar to or the same as weight application module 24 (shown in FIG. 1 and described above).

At an operation 48, a statistical description of the subsurface volume of interest may be determined based on the weighted samples. The statistical description may include a histogram and/or related statistics (e.g., cumulative histogram, mean, median, mode, variance, etc.), and/or other statistical descriptions. In one embodiment, operation 48 is performed by a statistical description module similar to or the same as statistical description module 26 (shown in FIG. 1 and described above). Method 40 could include further processing of the weights, the weighted samples, and/or the statistical description.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A computer-implemented method of declustering a property within a subsurface volume of interest, the method comprising:
obtaining values of a property for some locations within a three-dimensional subsurface volume of interest such that for some locations within the subsurface volume of interest the value of the property is unknown;
defining a first slice through the subsurface volume of interest, the first slice including locations for which the property is known and locations for which the property is unknown; and
determining declustering weights for the obtained values for the property across the first slice, wherein the determination of the declustering weights for obtained values of the property at locations in the first slice is made by applying an interpolating technique to the obtained values of the property at locations in the first slice.

2. The method of claim 1, wherein the determination of the declustering weights for obtained values of the property at locations in the first slice is made without regard for values of the property at locations outside of the first slice.

3. The method of claim 1, further comprising:
defining a second slice through the subsurface volume of interest, the second slice including locations for which the property is known and locations for which the property is unknown; and
determining declustering weights for the obtained values for the property across the second slice, wherein the determination of the declustering weights for obtained values of the property at locations in the second slice is made by applying an interpolating technique to the obtained values of the property at locations in the second slice.

4. The method of claim 3, further comprising iteratively defining slices through the subsurface volume of interest and determining declustering weights for obtained values of the property at locations within the defined slices until values for the property have been obtained throughout the subsurface volume of interest.

5. The method of claim 1, wherein the first slice is a common-time slice, a common-depth slice, a common-horizon slice, a slice oriented along a primary direction of spatial continuity, or a vertical slice.

6. The method of claim 1, further comprising creating a statistical description of the subsurface volume of interest, wherein in creating the statistical description the samples are weighted in accordance with the corresponding weights.

7. The method of claim 1, wherein the interpolating technique comprises one or more of a kriging technique, a inverse distance method, or a polygon-of-influence technique.

8. The method of claim 1, wherein the determination of the declustering weights in the first slice is based on a variogram of the values of the property for locations in the first slice, and wherein application of the interpolating technique includes determining the variogram based on the values of the property for locations in the first slice.

9. The method of claim 8, wherein the variogram is determined without regard for values of the property for locations outside of the first slice.

10. The method of claim 1, wherein the property includes one or more of a reservoir property, a lithologic property, or a seismic property.

11. A system configured to interpolate a property within a subsurface volume of interest, the system comprising:
electronic storage storing values of a property for some locations within a three-dimensional subsurface volume of interest such that for some locations within the subsurface volume of interest the value of the property is unknown; and
one or more processors executing computer program modules, the computer program modules including:
a slicing module configured to define slices through the subsurface volume of interest such that individual slices include locations for which the property is known and locations for which the property is unknown; and
a weight determination module configured to determine declustering weights for the obtained values for the property on a slice-by-slice basis, wherein the determination of the declustering weights for obtained values of the property on a slice-by-slice basis is made by separately applying an interpolating technique to obtained values of the property at locations in individual slices.

12. The system of claim 11, wherein the weight determination module is configured such that responsive to the slicing module defining a first slice, the determination of declustering weights for values of the property at locations in the first slice is performed without regard for values of the property at locations in the subsurface volume of interest outside of the first slice.

13. The system of claim 11, wherein the slicing module is configure such that the slices include one or more of a common-time slice, a common-depth slice, a common-horizon slice, a slice oriented along a primary direction of spatial continuity, or a vertical slice.

14. The system of claim 11, wherein the computer program modules further include a statistical description module configured to determine a statistical description of the subsurface volume of interest, wherein the statistical description module is configured to base the statistical description on the samples after the samples have been weighted by the corresponding weights.

15. The system of claim 11, wherein the interpolating technique comprises one or more of a kriging technique, a inverse distance method, or a polygon-of-influence technique.

16. The system of claim 11, wherein the weight determination module is configured to determine the declustering weights based on a variogram of the values of the property for locations, and wherein weight determination module is configured to determine the variogram.

17. The system of claim 16, wherein the weight determination module is configured to determine the variogram on a slice-by-slice basis.

18. The system of claim 11, wherein the property includes one or more of a reservoir property, a lithologic property, or a seismic property.

19. An electronic, computer-readable, non-transitory storage medium storing instructions configured to cause one or more processors to perform a method of interpolating a property within a subsurface volume of interest, the method comprising:
obtaining values of a property for some locations within a three-dimensional subsurface volume of interest such that for some locations within the subsurface volume of interest the value of the property is unknown;
defining a first slice through the subsurface volume of interest, the first slice including locations for which the property is known and locations for which the property is unknown; and
determining declustering weights for the obtained values for the property across the first slice, wherein the determination of the declustering weights for obtained values of the property at locations in the first slice is made by applying an interpolating technique to the obtained values of the property at locations in the first slice.

20. The storage medium of claim 19, wherein the determination of the declustering weights for obtained values of the property at locations in the first slice is made without regard for values of the property at locations outside of the first slice.
